(19) United States
(12) Patent Application Publication
(10) Pub. No.: US 2006/0003290 A1
(43) Pub. Date: Jan. 5, 2006

(54) Endosseous one-piece screw-type dental implants

(76) Inventor: Gerald A. Niznick, Las Vegas, NV (US)

Correspondence Address: BRIGHT & LORIG, P.C., Suite 3330, 633 West Fifth Street, Los Angeles, CA, 90071, US

(21) Appl. No.: 10/883,275

(22) Filed: Jul. 1, 2004

(51) Int. Cl. A61C 8/00

(52) U.S. Cl. 433/174

(57) ABSTRACT

Externally-threaded endosseous dental implants that include the structure of an implant body and an abutment/head also include, between the head portion and the body portion, a beveled shoulder portion that extends downwardly and outwardly from the head portion.

This invention relates to endosseous dental implants, particularly to externally-threaded endosseous dental implants that combine the structure of an endosseous dental implant and an abutment.

These endosseous dental implants include a body portion that may be tapered or untapered, and may include a plurality of external, separate lead threads, or a single external thread over all or a portion of the implant body. The body portion of this implant may have a length in the range of about 6 to about 18 mm, a diameter in the range of about 2 to about 7 mm, and may, in whole or in part, have a surface that is machined, roughened by blasting or etching, coated with Hydroxylapatite, or any combination of these surface treatments. The implant may have any desired thread design/pitch, and may include cutting grooves or apical vents near the distal end.

The proximal end of these implants comprises a tapered head that functions as an abutment. This tapered head may comprise a truncated cone that may include one or more flat areas or partial grooves on its external surface. Between the body portion of the implant and the tapered head portion is a beveled shoulder that slopes downwardly and outwardly from the tapered head portion to a circumferential surface that may have a height in the range of about 4 to about 10 mm. In some embodiments, the shoulder slopes downwardly and inwardly from this circumferential surface into the body portion of the implant. In other embodiments, the shoulder may taper downwardly and outwardly, or may extend downwardly to form a substantially cylindrical surface. A downwardly, inwardly tapering portion may be beveled, and/or may have a slope in the range of about 5 to about 45 degrees. A downwardly, outwardly tapering portion may be beveled, and/or may have a slope in the range of about 5 to about 45 degrees. A downwardly-extending cylindrical portion may be about 0.5 to about 4 mm in length. The beveled shoulder may have an overall length in the range of about 0.25 to about 3 mm. The angular slope of the proximal portion of the beveled shoulder is about 10 to about 60 degrees.

The shoulder minimizes the need to prepare an abutment in a patient's mouth, and forms a finish line for seating and sealing a crown margin. The shoulder also provides adequate space for an aesthetic porcelain restoration. The shoulder also facilitates aesthetic placement of the margin under the soft tissue in a patient's mouth.

These implants may also include, on the external surface of the head portion, inwardly-projecting grooves/notches/indentations. See U.S. patent application Ser. No. 10/741,023, filed Dec. 19, 2003, and entitled “Multi-Part Abutment And Transfer Cap For Use With An Endosseous Dental Implant With Non-Circular, Beveled Implant/Abutment Interface,” describing both such structures, and a transfer cap that snaps into such structures.

These transfer caps comprise a hollow tube closed at the proximal end and open at the distal end, preferably having a cylindrical profile. At or near the closed proximal end of these caps is an undercut region, which may comprise one or more circumferential grooves, or a plurality of openings spaced apart from one another. The distal end of these caps is open to an internal passage that includes, on the inside wall surface, at or near the opening, one or more retention projections that snap/fit into inwardly-projecting grooves/notches/indentations on the outer surface of the head portion of an abutment.

In some embodiments, retention projections on the wall of the inner surface of the transfer caps comprise one or more said projections, complementary in size and shape to the inwardly-projecting grooves/notches/indentations on the outer surface of the head portion.

In use, after the endosseous dental implant is placed in a patient's mouth, the transfer cap is placed over the head portion. The internal projection or projections fit or snap into one or more of the externally-formed grooves, notches or other inwardly-projecting indentations on the outer surface of the head portion. When so placed, the bottom of the transfer cap preferably seats on the upper exposed surface of the implant including the beveled shoulder.

### BRIEF DESCRIPTION OF THE DRAWINGS

These one-piece externally-threaded screw-type dental implants can better be understood by reference to the drawings, in which:

FIG. 1 shows an embodiment of one such implant, including an externally-threaded body portion, a cutting groove near its distal end, and, atop the body portion, a downwardly, outwardly angled, beveled shoulder, with a distally-positioned, inwardly tapered portion, and a tapered head including one or more flat areas;

FIG. 1A shows an alternate embodiment of the implant of FIG. 1, including an externally-threaded body portion, a cutting groove near its distal end, and, atop the body portion, a downwardly, outwardly angled, beveled shoulder, with a distally-positioned straight cylindrical portion, and a tapered head including one or more flat areas;

FIG. 1B shows another alternate embodiment of the implant of FIG. 1, including an externally-threaded body portion, a cutting groove near its distal end, and, atop the body portion, a downwardly, outwardly angled, beveled shoulder, with a contiguous distally-positioned, beveled portion, with two distinct parts, and a tapered head including one or more flat areas;

FIG. 2 shows an embodiment of another such implant, including an externally-threaded body portion, a cutting groove near its distal end, and, atop the body portion, a downwardly, outwardly angled, beveled shoulder, with a distally-positioned, inwardly tapered portion, and a tapered head including one or more flat areas, and an opening from the proximal end of the implant into an internally-threaded passage in which the threads begin at, or below, the opening, continue into, and terminate within the implant;

FIG. 2A shows an alternate embodiment of the implant of FIG. 2, including an externally-threaded body portion, a cutting groove near its distal end, and, atop the body portion, a downwardly, outwardly angled, beveled shoulder, with a distally-positioned straight cylindrical portion, and a tapered head including one or more flat areas, and an opening from the proximal end of the implant into an internally-threaded passage in which the threads begin at, or below, the opening, continue into, and terminate within the implant;

FIG. 2B shows an alternate embodiment of the implant of FIG. 2, including an externally-threaded body portion, a cutting groove near its distal end, and, atop the body portion, a downwardly, outwardly angled, beveled shoulder, with two distinct parts, a tapered head including one or more flat areas, and an opening from the proximal end of the implant into an internally-threaded passage in which the threads begin at, or below, the opening, continue into, and terminate within the implant;

FIG. 3 shows an embodiment of another such implant, including an externally-threaded body portion, a cutting groove near its distal end, and, atop the body portion, a downwardly, outwardly angled, beveled shoulder, with a distally-positioned, inwardly tapered portion, a tapered head including one or more flat areas, and an opening from the proximal end of the implant, into an internal passage that includes wrench-engaging surfaces;

FIG. 3A shows an alternate embodiment of the implant of FIG. 3, including an externally-threaded body portion, a cutting groove near its distal end, and, atop the body portion, a downwardly, outwardly angled, beveled shoulder, with a distally-positioned straight cylindrical portion, a tapered head including one or more flat areas, and an opening from the proximal end of the implant, into an internal passage that includes wrench-engaging surfaces;

FIG. 3B shows another alternate embodiment of the implant of FIG. 3, including an externally-threaded body portion, a cutting groove near its distal end, and, atop the body portion, a downwardly, outwardly angled, beveled shoulder, with two distinct parts, a tapered head including one or more flat areas, and an opening from the proximal end of the implant, into an internal passage that includes wrench-engaging surfaces;

FIG. 4 shows an embodiment of another such implant, including an externally-threaded body portion, a cutting groove near its distal end, and, atop the body portion, a downwardly, outwardly angled, beveled shoulder, with a distally-positioned, inwardly tapered portion, a tapered head including one or more flat areas, and an opening from the proximal end of the implant into an internally-threaded passage that includes wrench-engaging surfaces and a threaded region in which the threads begin at, or below, the opening, continue into, and terminate within the implant;

FIG. 4A shows an alternate embodiment of the implant of FIG. 4, including an externally-threaded body portion, a cutting groove near its distal end, and, atop the body portion, a downwardly, outwardly angled, beveled shoulder, with a distally-positioned straight cylindrical portion, a tapered head including one or more flat areas, and an opening from the proximal end of the implant into an internally-threaded passage that includes wrench-engaging surfaces and a threaded region in which the threads begin at, or below, the opening, continue into, and terminate within the implant; and

FIG. 4B shows another alternate embodiment of the implant of FIG. 4, including an externally-threaded body portion, a cutting groove near its distal end, and, atop the body portion, a downwardly, outwardly angled, beveled shoulder, with two distinct parts, a tapered head including one or more flat areas, and an opening from the proximal end of the implant into an internally-threaded passage that includes wrench-engaging surfaces and a threaded region in which the threads begin at, or below, the opening, continue into, and terminate within the implant.

### DETAILED DESCRIPTION OF THE DRAWINGS

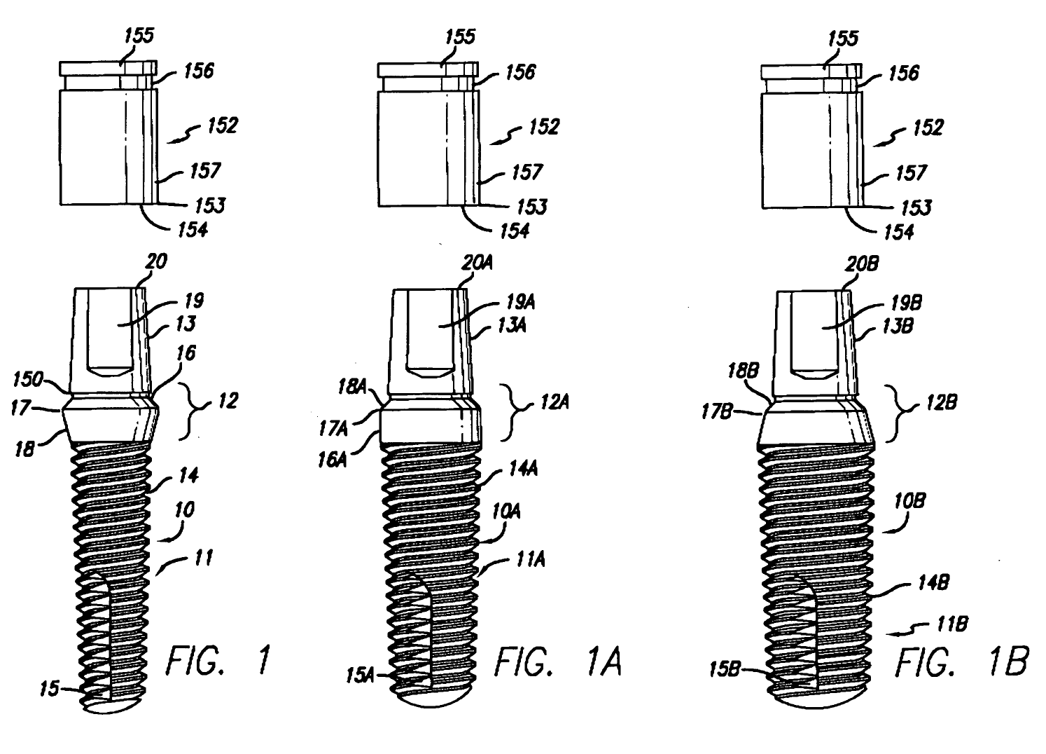

FIG. 1 shows an embodiment of a one-piece endosseous dental implant 10, that includes an externally-threaded portion 11 and, atop body portion 11, beveled shoulder 12. Atop shoulder 12 is tapered head 13, that serves as an integral abutment. Body portion 11 includes external threads 14 and apical cutting threads 15. Shoulder 12 includes downwardly, outwardly-angled portion 16, outer edge 17, and downwardly, inwardly angled portion 18. Tapered head 13 forms a frusto-conical cone having a flat surface 20 at the proximal end of implant 10. Head portion 13 includes one or more flat surfaces 19 for engaging an implant placement tool to facilitate placement of the implant in a patient's mouth.

FIG. 1A shows an alternate embodiment of FIG. 1, here a one-piece endosseous dental implant 10A, that includes an externally-threaded body portion 11A and, atop body portion 11A, shoulder 12A. Atop shoulder 12A is tapered head 13A, that serves as an integral abutment. Body portion 11A includes external threads 14A and apical cutting threads 15A. Shoulder 12A includes downwardly, outwardly angled portion 18A, outer edge 17A, and circumferential, untapered portion 16A. Atop portion 18A is tapered head 13A forming a frusto-conical cone having a flat surface 20A at the proximal end of implant 10A. Head portion 13A includes one or more flat surfaces 19A for engaging an implant placement tool to facilitate placement of the implant in a patient's mouth.

FIG. 1B shows another alternate embodiment of FIG. 1, here a one-piece endosseous dental implant 10B, that includes an externally-threaded body portion 11B and, atop body portion 11B, shoulder 12B. Atop shoulder 12B is tapered head 13B, that serves as an integral abutment. Body portion 11B includes external threads 14B and apical cutting threads 15B. Shoulder 12B includes downwardly, outwardly angled portion 18B having two distinct outwardly tapering regions, joined at outer edge 17B. Atop portion 18B is tapered head 13B forming a frusto-conical cone having a flat surface 20B at the proximal end of implant 10B. Head portion 13B includes one or more flat surfaces 19B for engaging an implant placement tool to facilitate placement of the implant in a patient's mouth.

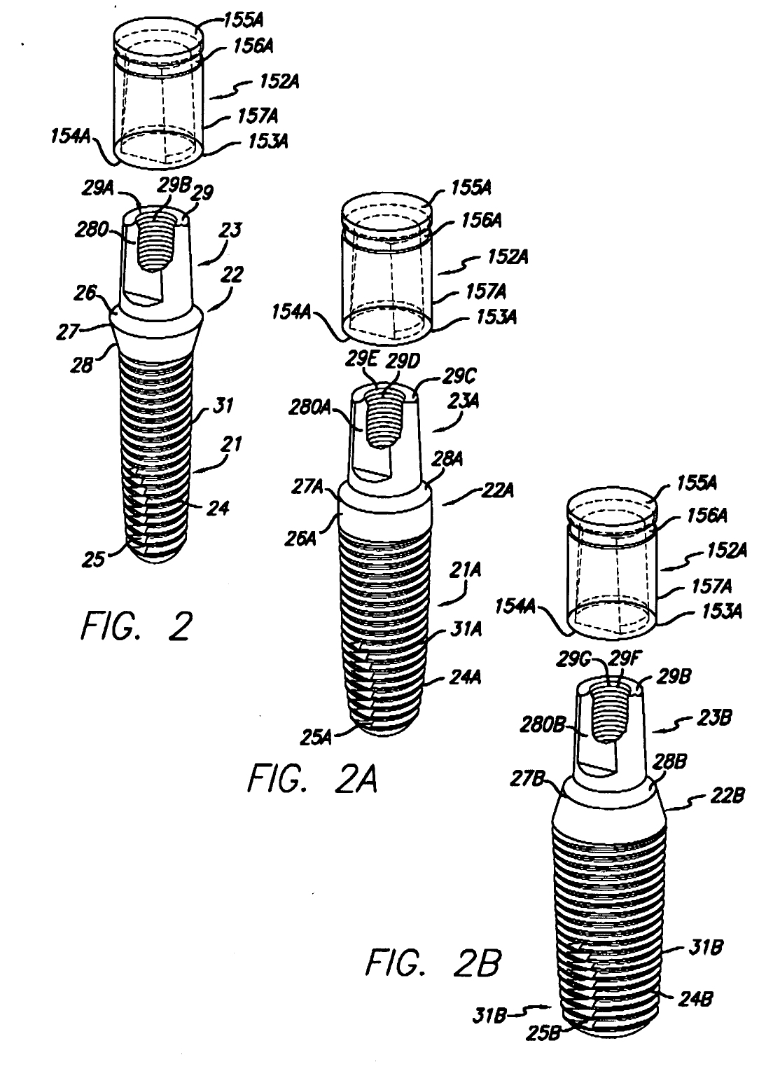

FIG. 2 shows an embodiment of a one-piece endosseous dental implant 21, that includes an externally-threaded body portion 31 and, atop body portion 31, shoulder 22. Atop shoulder 22 is tapered head 23, that serves as an integral abutment. Body portion 31 includes external threads 24 and apical cutting threads 25. Shoulder 22 includes downwardly, outwardly-angled portion 26, outer edge 27, and downwardly, inwardly-angled portion 28. Atop portion 28 is head portion 23 forming a frusto-conical cone having a flat surface 29 at the proximal end of implant 21. Head portion 23 includes one or more flat surfaces 280 for engaging an implant placement tool to facilitate placement of implant 21 in a patient's mouth. Surface 29 includes an opening 29A into internally-threaded passage/shaft 29B. The threads in this passage begin at or near opening 29A, and extend distally, ending inside implant 21.

FIG. 2A shows an alternate embodiment of FIG. 2, here a one-piece endosseous dental implant 21A, that includes an externally-threaded body portion 31A and, atop body portion 31A, shoulder 22A. Atop shoulder 22A is tapered head 23A, that serves as an integral abutment. Body portion 31A includes external threads 24A and apical cutting threads 25A. Shoulder 22A includes downwardly, outwardly angled portion 28A, outer edge 27A, and circumferential untapered portion 26A. Atop portion 22A is tapered head 23A forming a frusto-conical cone having a flat surface 29C at the proximal end of implant 21A. Head portion 23A includes one or more flat surfaces 280A for engaging an implant placement tool to facilitate placement of the implant in a patient's mouth. Surface 29C includes an opening 29D into internally-threaded passage/shaft 29E. The threads in passage 29E begin at or near opening 29D, and extend distally to end inside implant 21A.

FIG. 2B shows another alternative embodiment of FIG. 2, here a one-piece endosseous dental implant 31B, that includes an externally-threaded body portion 31C and, atop body portion 31C, shoulder 22B. Atop shoulder 22B is tapered head 23B, that serves as an integral abutment. Body portion 31C includes external threads 24B and apical cutting threads 25B. Shoulder 22B includes downwardly, outwardly angled portion 28B having two distinct outwardly tapering regions, joined to one another at outer edge 27B. Atop portion 22B is tapered head 23B forming a frusto-conical cone having a flat surface 29B at the proximal end of implant 31B. Head portion 23B includes one or more flat surfaces 280B for engaging an implant placement tool to facilitate placement of the implant in a patient's mouth. Surface 29 includes an opening 29F into internally-threaded passage/shaft 29G. The threads in passage 29G begin at or near opening 29F and extend distally, ending inside implant 31B.

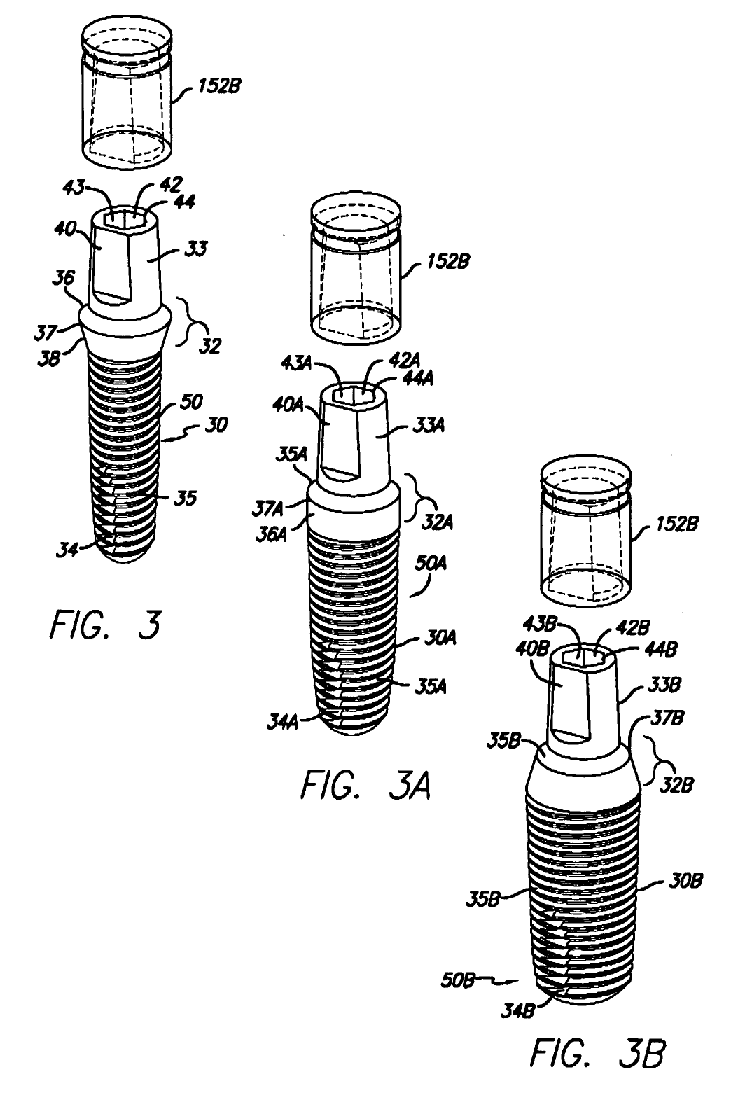

FIG. 3 shows an embodiment of a one-piece endosseous dental implant 30 that includes an externally-threaded body portion 50 and, atop body portion 50, shoulder 32. Atop shoulder 32 is tapered head 33, that serves as an integral abutment. Body portion 50 includes external threads 35 and apical cutting threads 34. Shoulder 32 includes downwardly, outwardly angled beveled portion 36, outer edge 37, and downwardly, inwardly tapering portion 38. Atop shoulder 32 is head portion 33, forming a frusto-conical cone having a flat surface 44 at the proximal end of implant 30. Head portion 33 includes one or more flat surfaces 40 for engaging an implant placement tool to facilitate placement of the implant in a patient's mouth.

The implant of FIG. 3 also includes, in head portion 38, internal passage 42 that includes internal wrench-engaging surfaces 43 inside passage 42. Passage 42 extends from top flat surface 44, inside of, and terminates within implant 30.

FIG. 3A shows an alternate embodiment of the implant of FIG. 3, here a one-piece endosseous dental implant 50A that includes an externally-threaded body portion 30A and, atop body portion 30A, shoulder 32A. Atop shoulder 32A is tapered head 33A, that serves as an integral abutment. Body portion 30A includes external threads 35A and apical cutting threads 34A. Shoulder 32A includes downwardly, outwardly angled beveled portion 35A, outer edge 37A, and circumferential, untapered portion 36A. Atop portion 30A is head portion 33A, forming a frusto-conical cone having a flat surface 44A at the proximal end of implant 50A. Head portion 33A includes one or more flat surfaces 40A for engaging an implant placement tool to facilitate placement of the implant in a patient's mouth.

The implant of FIG. 3A also includes, in head portion 33A, internal passage 42A that includes internal wrench-engaging surfaces 43A inside passage 42A. Passage 42A extends from top flat surface 44A, inside of, and terminates within implant 30A.

FIG. 3B shows another alternate embodiment of the implant of FIG. 3, here a one-piece endosseous dental implant 50B that includes an externally-threaded body portion 30B and, atop body portion 30B, shoulder 32B. Atop shoulder 32B is tapered head 33B, that serves as an integral abutment. Body portion 50B includes external threads 35B and apical cutting threads 34B. Shoulder 32B includes downwardly, outwardly angled beveled portion 35B with two distinct outwardly angled portions, joined to one another at outer edge 37B. Atop portion 32B is head portion 33B, forming a frusto-conical cone having a flat surface 44B at the proximal end of implant 50B. Head portion 33B includes one or more flat surfaces 40B for engaging an implant placement tool to facilitate placement of the implant in a patient's mouth.

The implant of FIG. 3B also includes, in head portion 38B, internal passage 42B that includes internal wrench-engaging surfaces 43B inside passage 42B. Passage 42B extends from top flat surface 44B, inside of, and terminates within implant 50B.

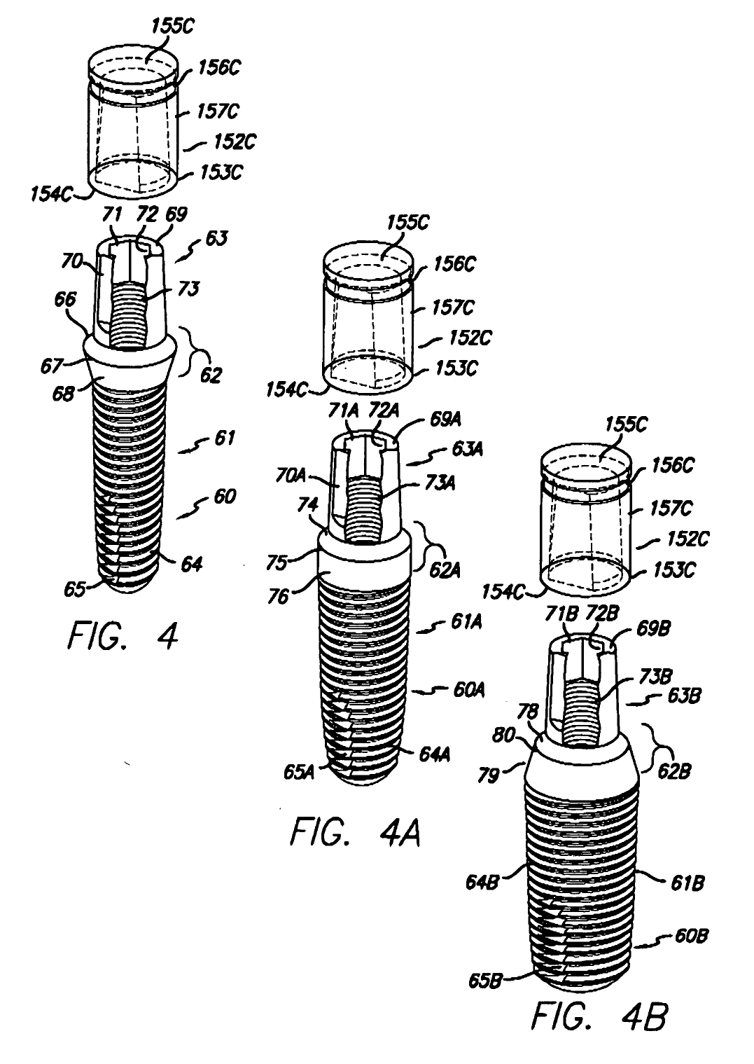

FIG. 4 shows an embodiment of a one-piece endosseous dental implant 60 that includes an externally-threaded body portion 61 and, atop body portion 61, shoulder 62. Atop shoulder 62 is tapered head 63, that serves as an integral abutment. Body portion 61 includes external threads 64 and apical cutting threads 65. Shoulder 62 includes downwardly, outwardly angled beveled portion 66, outer edge 67, and downwardly, inwardly tapering portion 68. Atop shoulder 62 is head portion 63 forming a frusto-conical cone having a flat surface 69 at the proximal end of implant 60. Head portion 63 includes one or more flat surfaces 70 for engaging an implant placement tool to facilitate placement of implant 60 in a patient's mouth.

The implant of FIG. 4 also includes, in head portion 63, internal passage 71 that includes internal wrench-engaging surfaces 72 and threaded region 73 inside passage 71. Passage 71 extends from top flat surface 69, inside of, and terminates within implant 60.

FIG. 4A shows an alternate embodiment of the implant of FIG. 4, here a one-piece endosseous dental implant 60A that includes an externally-threaded body portion 61A and, atop body portion 61A, shoulder 62A. Atop shoulder 62A is tapered head 63A, that serves as an integral abutment. Body portion 61A includes external threads 6435A and apical cutting threads 65A. Shoulder 62A includes downwardly, outwardly angled beveled portion 74, outer edge 75, and circumferential, untapered portion 76. Atop portion 61A is head portion 63A, forming a frusto-conical cone having a flat surface 69A at the proximal end of implant 60A. Head portion 63A includes one or more flat surfaces 70A for engaging an implant placement tool to facilitate placement of implant 60A in a patient's mouth.

The implant of FIG. 4A also includes, in head portion 63A, internal passage 72A that includes internal wrench-engaging surfaces 71A and threaded region 73A inside passage 72A. Passage 72A extends from top flat surface 69A, inside of, and terminates within implant 60A.

FIG. 4B shows another alternate embodiment of the implant of FIG. 4, here a one-piece endosseous dental implant 60B that includes an externally-threaded body portion 61B and, atop body portion 61B, shoulder 62B. Atop shoulder 62B is tapered head 63B, that serves as an integral abutment. Body portion 61B includes external threads 64B and apical cutting threads 65B. Shoulder 62B includes downwardly, outwardly angled beveled portion 77 with two distinct outwardly angled portions, 78 and 79, joined to one another at outer edge 80. Head portion 63B forms a frusto-conical cone having a flat surface 69B at the proximal end of implant 60B. Head 63B includes one or more flat surfaces 70D for engaging an implant placement tool to facilitate placement of the implant in a patient's mouth.

The implant of FIG. 4B also includes, in head 63B, internal passage 72B that includes internal wrench-engaging surfaces 71B and threaded region 73B inside passage 72B. Passage 63B extends from top flat surface 69B, inside of, and terminates within implant 60B.

FIGS. 1, 1A, 1B, 2, 2A, 2B, 3, 3A, 3B, 4, 4A and 4B, show transfer caps 152, 152A, 152B and 152C, positioned over head portions of the implants. These transfer caps 152, 152A, 152B and 152C have a right cylindrical body portion 157, 157A, 157B and 157C, including closed, flat, proximal ends 155, 155A, 155B and 155C, and upper, external retention structures 156, 156A, 156B and 156C. Retention structures 156, 156A, 156B and 156C are circumferential grooves formed just below top surfaces 155, 155A, 155B and 155C. Transfer caps 152, 152A, 152B and 152C are open at end 154, 154A, 154B and 154C. Inside transfer caps 152, 152A, 152B and 152C are hollow passages.

Transfer caps 152, 152A, 152B and 152C are of sufficient length and diameter to fit over the head portions of the implants when the distal surfaces around opening 154, 154A, 154B and 154C are seated on the upper surfaces of the implants. On transfer caps 152, 152A, 152B and 152C, at or near opening 154, 154A, 154B and 154C, are a plurality of projections or protrusion 153. These protrusions are of a size and shape complementary to inward projections, such as inward projection 150, on the implants.

1. An externally-threaded endosseous dental implant comprising:
a tapered head portion at its proximal end, said head portion tapering downwardly to a beveled shoulder portion, said shoulder portion tapering downwardly and outwardly from said head portion to an externally-threaded body portion.

2. The endosseous dental implant of claim 1 wherein said tapered head portion includes at least one flat area adapted to engage an implant placement tool.

3. The endosseous dental implant of claim 1 wherein said tapered head portion includes at least one vertical groove adapted to engage an implant placement tool.

4. The endosseous dental implant of claim 1 or claim 2 wherein said body portion is straight or tapered and includes external single-lead or multiple-lead threads.

5. The endosseous dental implant of claim 1 or claim 2 or claim 3 wherein said beveled shoulder includes a distally-positioned cylindrical portion, or a distally-positioned downwardly, inwardly angled portion, or a downwardly, outwardly angled portion.

6. The endosseous dental implant of claim 1 or claim 2 or claim 3 wherein said tapered head portion includes an internal passage comprising internal wrench-engaging surfaces extending distally from the top of said implant, internal threads or both.

7. The endosseous dental implant of claim 6 wherein said internal passage is at least partially threaded.

8. The endosseous dental implant of claim 4 further comprising, on the external surface of said implant, one or more inwardly-extending indentations below the top of said implant, said one or more indentations having size and shape suitable to engage projections on a transfer cap that fits over said implant.
